(19) United States
(12) Patent Application Publication
(10) Pub. No.: US 2005/0216160 A1
(43) Pub. Date: Sep. 29, 2005

(54) Method for detecting electric-mechanical-brake pad drag and/or calculating actuator efficiency

(75) Inventors: Jon T. Zumberge, Centerville, OH (US); Melinda D. Simpson, Jamestown, OH (US); Deron C. Littlejohn, West Bloomfield, MI (US)

Correspondence Address: Delphi Technologies, Inc., M/C 480-410-202, P.O. Box 5052, Troy, MI, 48007-5052, US

(73) Assignee: Delphi Technologies Inc.

(21) Appl. No.: 11/013,867

(22) Filed: Dec. 16, 2004

Related U.S. Application Data
(60) Provisional application No. 60/555,722, filed on Mar. 23, 2004.

(51) Int. Cl. G06F 19/00

(52) U.S. Cl. 701/70

(57) ABSTRACT

Electric-mechanical-brake (EMB) pad drag is determined from measurements (which can include estimations) of EMB voltage, EMB actuator temperature, and either EMB current or EMB motor speed during an open-loop apply of the EMB pad and during an open-loop release of the EMB pad. An open-loop EMB actuator efficiency is calculated when certain conditions of the same measurements apply, whereupon the EMB actuator efficiency is calculated using at least the apply or release EMB current and a corresponding apply or release preselected (such as a nominal) EMB current or is calculated using at least the apply or release EMB motor speed and a corresponding apply or release preselected (such as a nominal) EMB motor speed.

### CROSS REFERENCE TO RELATED APPLICATIONS

The present application claims priority of U.S. Provisional Application No. 60/555,722 filed Mar. 23, 2004.

### TECHNICAL FIELD

The present invention relates generally to an electric mechanical brake (EMB), and more particularly to a method for detecting EMB pad drag and/or calculating actuator efficiency.

### BACKGROUND OF THE INVENTION

Conventional electric mechanical brakes, also known as electric brake calipers, utilize an electric motor to drive a rotatable ballscrew of a ballscrew subassembly. The rotating ballscrew linearly moves a ballnut of the ballscrew subassembly. The ballnut is connected by gearing to, and linearly moves, an inner brake pad against a brake rotor of a vehicle. An outer brake pad, mounted to the caliper housing, is positioned on an opposite side of the brake rotor. During braking, the inner brake pad will be forced against the rotor and a resulting reactionary force will pull the outer brake pad into engagement with the opposite side of the rotor. Engagement of the inner and outer brake pads with the rotor will slow and stop the vehicle or hold a stopped vehicle in a fixed position. The electric motor, the ballscrew subassembly, and the gearing together are referred to as an EMB (electric-mechanical-brake) actuator. Typically, a battery supplies a voltage to an electronic control unit (ECU) which applies a current to the motor to move the brake pads from a home position to a position against the brake rotor and which applies a reverse current to the motor to release and re-home the brake pads. The braking operation of electric mechanical brakes is well known in the art. Brake pad drag describes an undesirable condition, whether the vehicle is in motion or not, when the brake pad is supposed to be released but actually remains in contact with the brake rotor.

What is needed is a method for detecting electric-mechanical-brake (EMB) pad drag and/or actuator efficiency.

### SUMMARY OF THE INVENTION

A first method of the invention is for detecting electric-mechanical-brake (EMB) pad drag and includes steps a) through e). Step a) includes measuring an apply EMB current, an apply EMB voltage, and an apply EMB actuator temperature during an open-loop apply of the EMB pad. Step b) includes measuring a release EMB current, a release EMB voltage, and a release EMB actuator temperature during an open-loop release of the EMB pad. Step c) includes determining that the apply and release EMB voltage magnitudes are within a predetermined voltage difference and that the apply and release EMB actuator temperatures are within a predetermined temperature difference. Step d) includes determining that the apply and release EMB current magnitudes are not within a predetermined current difference. Step e) includes determining that the apply EMB current magnitude is greater than the release EMB current magnitude which indicates drag of the EMB pad.

A second method of the invention is for detecting electric-mechanical-brake (EMB) pad drag and includes steps a) through e). Step a) includes measuring an apply EMB motor speed, an apply EMB voltage, and an apply EMB actuator temperature during an open-loop apply of the EMB pad. Step b) includes measuring a release EMB motor speed, a release EMB voltage, and a release EMB actuator temperature during an open-loop release of the EMB pad. Step c) includes determining that the apply and release EMB voltage magnitudes are within a predetermined voltage difference and that the apply and release EMB actuator temperatures are within a predetermined temperature difference. Step d) includes determining that the apply and release EMB motor speed magnitudes are not within a predetermined motor speed difference. Step e) includes determining that the apply EMB motor speed magnitude is less than the release EMB motor speed magnitude which indicates drag of the EMB pad.

A third method of the invention is for calculating a no-load electric-mechanical-brake (EMB) actuator efficiency and includes steps a) through e). Step a) includes measuring an apply EMB current, an apply EMB voltage, and an apply EMB actuator temperature during an open-loop apply of the EMB pad. Step b) includes measuring a release EMB current, a release EMB voltage, and a release EMB actuator temperature during an open-loop release of the EMB pad. Step c) includes determining that the apply and release EMB voltage magnitudes are within a predetermined voltage difference and that the apply and release EMB actuator temperatures are within a predetermined temperature difference. Step d) includes determining that the apply and release EMB current magnitudes are within a predetermined current difference. Step e) includes calculating the no-load EMB actuator efficiency using at least the apply or release EMB current and a corresponding apply or release preselected EMB current.

A fourth method of the invention is for calculating a no-load electric-mechanical-brake (EMB) actuator efficiency and includes steps a) through e). Step a) includes measuring an apply EMB motor speed, an apply EMB voltage, and an apply EMB actuator temperature during an open-loop apply of the EMB pad. Step b) includes measuring a release EMB motor speed, a release EMB voltage, and a release EMB actuator temperature during an open-loop release of the EMB pad. Step c) includes determining that the apply and release EMB voltage magnitudes are within a predetermined voltage difference and that the apply and release EMB actuator temperatures are within a predetermined temperature difference. Step d) includes determining that the apply and release EMB motor speed magnitudes are within a predetermined motor speed difference. Step e) includes calculating the no-load EMB actuator efficiency using at least the apply or release EMB motor speed and a corresponding apply or release preselected EMB motor speed.

Several benefits and advantages are derived from one or more of the methods of the invention. In one example of the first and/or second method of the invention, being able to detect EMB pad drag allows, in one embodiment, the EMB electronic control unit to adjust the EMB pad re-home position to eliminate such EMB pad drag which will improve gas mileage and improve vehicle handling. In one example of the third and/or fourth method of the invention, being able to calculate a no-load EMB actuator efficiency allows a calculation of a low efficiency to indicate (depending on temperature) that the EMB actuator, or a component thereof, is in need of repair or replacement.

### SUMMARY OF THE DRAWINGS

FIG. 1 is a flow chart of a first method of the invention for detecting EMB pad drag which includes measuring EMB currents;

FIG. 2 is a flow chart of a second method of the invention for detecting EMB pad drag which includes measuring EMB motor speeds;

FIG. 3 is a flow chart of a third method of the invention for calculating a no-load EMB actuator efficiency which includes measuring EMB currents; and

FIG. 4 is a flow chart of a fourth method of the invention for calculating a no-load EMB actuator efficiency which includes measuring EMB motor speeds.

### DETAILED DESCRIPTION

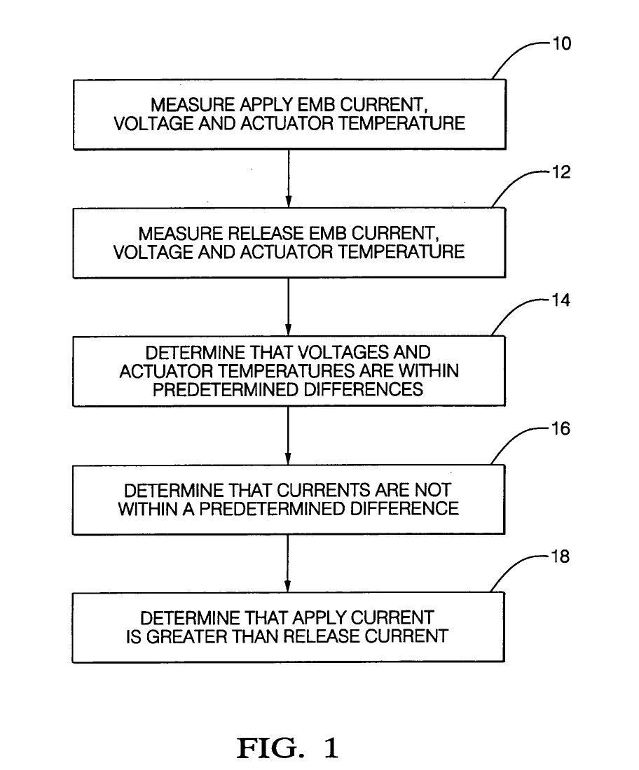

Referring now to the drawings, FIG. 1 shows a first method of the invention which is for detecting electric-mechanical-brake (EMB) pad drag and which includes steps a) through e). Step a) is labeled as “Measure Apply EMB Current, Voltage And Actuator Temperature” in block 10 of FIG. 1. Step a) includes measuring an apply EMB current, an apply EMB voltage, and an apply EMB actuator temperature during an open-loop apply of the EMB pad. Step b) is labeled as “Measure Release EMB Current, Voltage And Actuator Temperature” in block 12 of FIG. 1. Step b) includes measuring a release EMB current, a release EMB voltage, and a release EMB actuator temperature during an open-loop release of the EMB pad. Step c) is labeled as “Determine That Voltages And Actuator Temperatures Are Within Predetermined Differences” in block 14 of FIG. 1. Step c) includes determining that the apply and release EMB voltage magnitudes are within a predetermined voltage difference and that the apply and release EMB actuator temperatures are within a predetermined temperature difference. Step d) is labeled as “Determine That Currents Are Not Within A Predetermined Difference” in block 16 of FIG. 1. Step d) includes determining that the apply and release EMB current magnitudes are not within a predetermined current difference. Step e) is labeled as “Determine That Apply Current Is Greater Than Release Current” in block 18 of FIG. 1. Step e) includes determining that the apply EMB current magnitude is greater than the release EMB current magnitude which indicates drag of the EMB pad.

For purposes of describing any of the methods of the invention, the word “measuring” (as applied to temperature, current, voltage and/or speed) includes “estimating”. Thus, examples of measured EMB actuator temperatures include an estimate of rotor temperature, motor temperature, and/or ECU temperature. In one implementation of the first method, measured EMB actuator temperature is a measurement or estimation of EMB motor temperature. In one variation, measured apply and release EMB currents are measurements of a current in the EMB motor, and measured apply and release EMB voltages are measurements of a battery bus voltage or a voltage input to the ECU. Other examples, implementations, and variations are left to the artisan.

In one extension of the first method, there is also included the step of initiating an open-loop apply of the EMB pad and the step of initiating an open-loop release of the EMB pad. In one embodiment of apparatus, not shown, for carrying out the first method, a vehicle battery supplies a voltage to an EMB electronic control unit (ECU) which initiates the open-loop apply of the EMB pad and the open-loop release of the EMB pad. For the braking operation, the ECU uses open-loop control to apply a current to an EMB motor to move (via a ballscrew subassembly and gearing) the brake pads from a home position to a position against the brake rotor of a vehicle and which applies a reverse (release) current to the motor to release and re-home the brake pads. The EMB actuator includes the EMB motor, the ballscrew subassembly, and the gearing. As previously mentioned, brake pad drag describes an undesirable condition, whether the vehicle is in motion or not, when the brake pad is supposed to be released but actually remains in contact with the brake rotor.

For purposes of describing any of the methods of the invention, the terminology “open loop” (as used for an apply and/or a release of the EMB pad) is used to describe that a substantially consistent voltage or current is applied to the EMB motor for a substantially consistent period of time. In one example, without limitation, “open loop” indicates any voltage or current profile during normal operation that meets a criteria for substantial consistency of EMB motor command that is used in performing an EMB apply and/or an EMB release in any of the methods of the invention.

In one application of the first method, steps a) and b) are performed when the brake pad is presumed not to be dragging against the brake rotor. In one employment of the first method, the predetermined temperature difference is ten degrees Celsius. In the same or a different employment, the predetermined current difference is one-half ampere. In the same or a different employment, the predetermined voltage difference is one volt. In one variation, the predetermined temperature, current and voltage differences are empirically determined, as is within the level of skill of the artisan.

In one illustration of the first method, steps a) through e) are performed in alphabetic order. In one extension of this illustration of the first method, a brake event occurs between steps a) and b). In the same or a different extension, if any of steps c) and e) fail in their determining, the method restarts at step a).

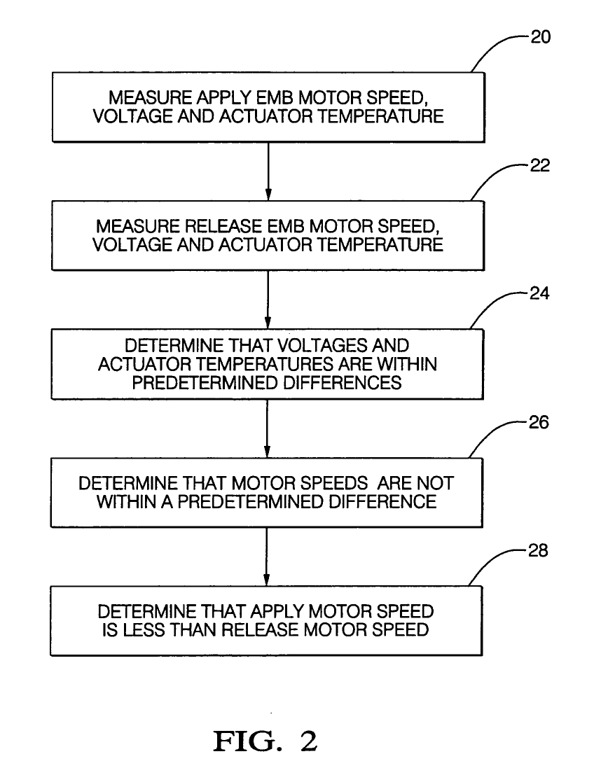

Referring again to the drawings, FIG. 2 shows a second method of the invention which is for detecting electric-mechanical-brake (EMB) pad drag and which includes steps a) through e). Step a) is labeled as “Measure Apply EMB Motor Speed, Voltage And Actuator Temperature” in block 20 of FIG. 2. Step a) includes measuring an apply EMB motor speed, an apply EMB voltage, and an apply EMB actuator temperature during an open-loop apply of the EMB pad. Step b) is labeled as “Measure Release EMB Speed, Voltage And Actuator Temperature” in block 22 of FIG. 2. Step b) includes measuring a release EMB motor speed, a release EMB voltage, and a release EMB actuator temperature during an open-loop release of the EMB pad. Step c) is labeled as “Determine That Voltages And Actuator Temperatures Are Within Predetermined Differences” in block 24 of FIG. 2. Step c) includes determining that the apply and release EMB voltage magnitudes are within a predetermined voltage difference and that the apply and release EMB actuator temperatures are within a predetermined temperature difference. Step d) is labeled as “Determine That Motor Speeds Are Not Within A Predetermined Difference” in block 26 of FIG. 2. Step d) includes determining that the apply and release EMB motor speed magnitudes are not within a predetermined motor speed difference. Step e) is labeled as “Determine That Apply Motor Speed Is Less Than Release Motor Speed” in block 28 of FIG. 2. Step e) includes determining that the apply EMB motor speed magnitude is less than the release EMB motor speed magnitude which indicates drag of the EMB pad.

In one variation of the second method of the invention, measured apply and release EMB motor speeds are derived from rotational position measurements of the shaft of the EMB motor. In one employment of the second method, the predetermined motor speed difference is 190 rpm (revolutions per minute). Other variations and employments are left to the artisan. In one application, the predetermined motor speed difference is empirically determined, as is within the level of skill of the artisan. It is noted that the embodiments, employments, illustrations, etc. of the previously-described first method are equally applicable to the second method, as can be appreciated by the artisan, wherein the references to EMB current in the first method are replaced with EMB motor speed for the second method.

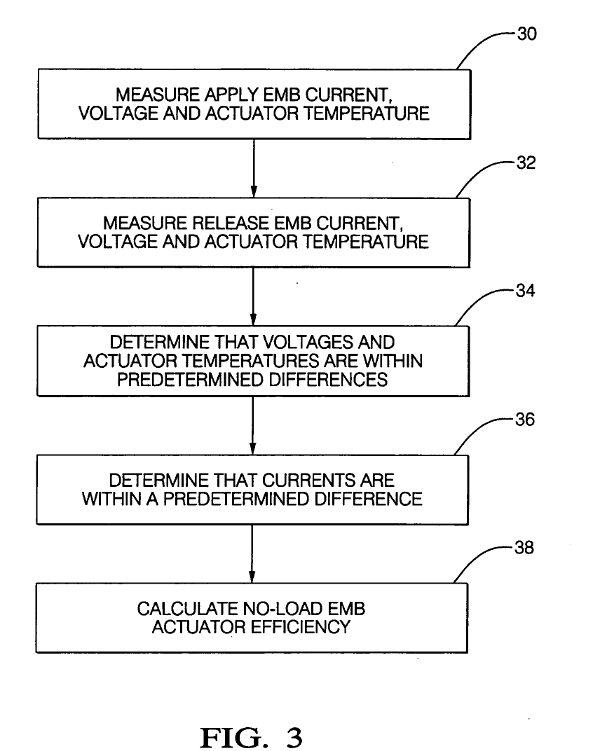

Referring again to the drawings, FIG. 3 shows a third method of the invention which is for calculating a no-load electric-mechanical-brake (EMB) actuator efficiency and which includes steps a) through e). Step a) is labeled as “Measure Apply EMB Current, Voltage And Actuator Temperature” in block 30 of FIG. 3. Step a) includes measuring an apply EMB current, an apply EMB voltage, and an apply EMB actuator temperature during an open-loop apply of the EMB pad. Step b) is labeled as “Measure Release EMB Current, Voltage And Actuator Temperature” in block 32 of FIG. 3. Step b) includes measuring a release EMB current, a release EMB voltage, and a release EMB actuator temperature during an open-loop release of the EMB pad. Step c) is labeled as “Determine That Voltages And Actuator Temperatures Are Within Predetermined Differences” in block 34 of FIG. 3. Step c) includes determining that the apply and release EMB voltage magnitudes are within a predetermined voltage difference and that the apply and release EMB actuator temperatures are within a predetermined temperature difference. Step d) is labeled as “Determine That Currents Are Within A Predetermined Difference” in block 36 of FIG. 3. Step d) includes determining that the apply and release EMB current magnitudes are within a predetermined current difference. Step e) is labeled as “Calculate No-Load EMB Actuator Efficiency” in block 38 of FIG. 3. Step e) includes calculating the no-load EMB actuator efficiency using at least the apply or release EMB current and a corresponding apply or release preselected EMB current. It is noted that the term “efficiency” includes relative efficiency and absolute efficiency.

In one illustration of the third method, the no-load EMB actuator efficiency is equal to one minus a function of the difference between the apply or release EMB current and the preselected EMB current. For the purpose of describing the third method, the difference between the apply or release EMB current and the preselected EMB current is defined to be the apply or release EMB current minus the preselected EMB current.

In one application of the third method, the function is equal to a scale factor. In one variation, the scale factor is equal to one. In one example, the (apply or release) preselected EMB current is a nominal (apply or release) EMB current which, in one variation, is equal to substantially one-half ampere and which, in one modification, is empirically determined as is within the level of skill of the artisan. In this example, the EMB no-load actuator efficiency is a relative actuator efficiency from a nominal value. Other functions, scale factors, examples, variations, and modifications are left to the artisan. In one extension of the third method of the invention, step d) is used as a determination that there is no EMB pad drag. It is noted that steps a) through c) of the third method are identical to steps a) through c) of the first method and that step d) of the first method is a negative determination of step d) of the third method. It also is noted that the EMB no-load actuator efficiency also reflects the effect of grease on the actuator and that at low temperatures (e.g., less than minus ten degrees Celsius) the viscosity of the grease greatly reduces the actuator efficiency.

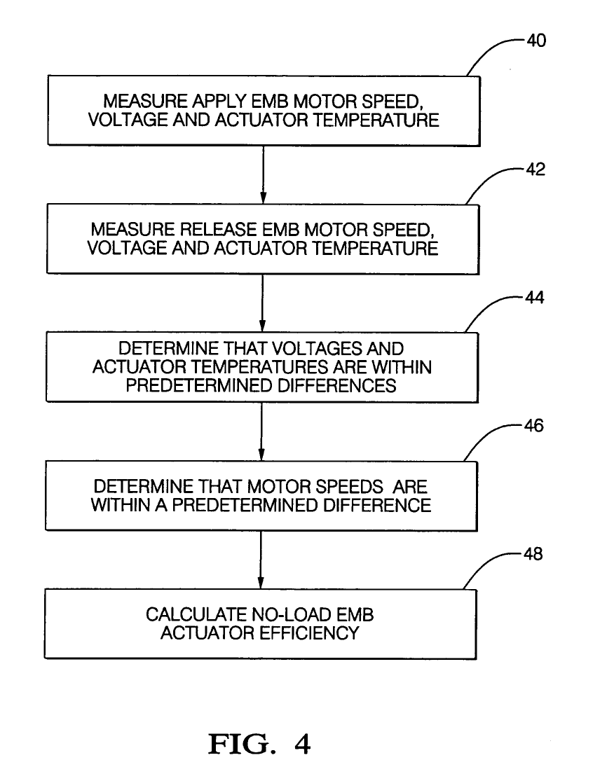

Referring again to the drawings, FIG. 4 shows a fourth method of the invention which is for calculating a no-load electric-mechanical-brake (EMB) actuator efficiency and which includes steps a) through e). Step a) is labeled as “Measure Apply EMB Motor Speed, Voltage And Actuator Temperature” in block 40 of FIG. 4. Step a) includes measuring an apply EMB motor speed, an apply EMB voltage, and an apply EMB actuator temperature during an open-loop apply of the EMB pad. Step b) is labeled as “Measure Release EMB Motor Speed, Voltage And Actuator Temperature” in block 42 of FIG. 4. Step b) includes measuring a release EMB motor speed, a release EMB voltage, and a release EMB actuator temperature during an open-loop release of the EMB pad. Step c) is labeled as “Determine That Voltages And Actuator Temperatures Are Within Predetermined Differences” in block 44 of FIG. 4. Step c) includes determining that the apply and release EMB voltage magnitudes are within a predetermined voltage difference and that the apply and release EMB actuator temperatures are within a predetermined temperature difference. Step d) is labeled as “Determine That Motor Speeds Are Within A Predetermined Difference” in block 46 of FIG. 4. Step d) includes determining that the apply and release EMB motor speed magnitudes are within a predetermined motor speed difference. Step e) is labeled as “Calculate No-Load EMB Actuator Efficiency” in block 48 of FIG. 4. Step e) includes calculating the no-load EMB actuator efficiency using at least the apply or release EMB motor speed and a corresponding apply or release preselected EMB motor speed. It is noted that the term “efficiency” includes relative efficiency and absolute efficiency.

In one illustration of the fourth method, the no-load EMB actuator efficiency is equal to one minus a function of the difference between the apply or release EMB motor speed. For the purpose of describing the fourth method, the difference between the preselected EMB motor speed and the apply or release EMB motor speed is defined to be the preselected EMB motor speed minus the apply or release EMB motor speed.

In one application of the fourth method, the function is equal to a scale factor. In one variation, the scale factor is equal to one. In one example, the preselected (apply or release) EMB motor speed is a nominal (apply or release) EMB motor speed which, in one variation, is equal to substantially 750 rpm and which, in one modification, is empirically determined as is within the level of skill of the artisan. In this example, the EMB no-load actuator efficiency is a relative actuator efficiency from a nominal value. Other functions, scale factors, examples, variations, and modifications are left to the artisan. In one extension of the fourth method of the invention, step d) is used as a determination that there is no EMB pad drag. It is noted that steps a) through c) of the fourth method are identical to steps a) through c) of the second method and that step d) of the second method is a negative determination of step d) of the fourth method.

It is further noted that the previously-described third or fourth method of the invention can be combined with either of the previously-described first or second method of the invention. In one variation, the previously-described first and third methods are combined with step d) of the first and third methods being rewritten as a branching step to step e) of the first or third methods. In another variation, the previously-described second and fourth methods are likewise combined.

In one embodiment of any of the first, second, third or fourth method of the invention, the method steps are implemented by a computer algorithm present in the ECU.

Several benefits and advantages are derived from one or more of the methods of the invention. In one example of the first and/or second method of the invention, being able to detect EMB pad drag allows, in one embodiment, the EMB electronic control unit to adjust the EMB pad re-home position to eliminate such EMB pad drag which will improve gas mileage and improve vehicle handling. In one example of the third and/or fourth method of the invention, being able to calculate a no-load EMB actuator efficiency allows a calculation of a low efficiency to indicate (depending on temperature) that the EMB actuator, or a component thereof, is in need of repair or replacement.

The foregoing description of several methods of the invention has been presented for purposes of illustration. It is not intended to be exhaustive or to limit the invention to the precise steps or forms disclosed, and obviously many modifications and variations are possible in light of the above teaching. It is intended that the scope of the invention be defined by the claims appended hereto.

1. A method for detecting electric-mechanical-brake (EMB) pad drag comprising:
a) measuring an apply EMB current, an apply EMB voltage, and an apply EMB actuator temperature during an open-loop apply of the EMB pad;
b) measuring a release EMB current, a release EMB voltage, and a release EMB actuator temperature during an open-loop release of the EMB pad;
c) determining that the apply and release EMB voltage magnitudes are within a predetermined voltage difference and that the apply and release EMB actuator temperatures are within a predetermined temperature difference;
d) determining that the apply and release EMB current magnitudes are not within a predetermined current difference; and
e) determining that the apply EMB current magnitude is greater than the release EMB current magnitude which indicates drag of the EMB pad.

2. The method of claim 1, also including the step of initiating an open-loop apply of the EMB pad, and the step of initiating an open-loop release of the EMB pad.

3. The method of claim 2, wherein the open-loop apply of the EMB pad is initiated by an EMB electronic control unit and applies the EMB pad against a brake rotor, and wherein the open-loop release of the EMB pad is initiated by the EMB electronic control unit.

4. The method of claim 3, wherein the apply and release EMB actuator temperatures are the apply and release temperatures of an EMB actuator which includes an EMB motor, which includes a ballscrew subassembly, and which includes gearing.

5. The method of claim 4, wherein EMB actuator temperature is EMB motor temperature, wherein EMB current is current in the EMB motor, and wherein EMB voltage is voltage input to the EMB electronic control unit.

6. A method for detecting electric-mechanical-brake (EMB) pad drag comprising:
a) measuring an apply EMB motor speed, an apply EMB voltage, and an apply EMB actuator temperature during an open-loop apply of the EMB pad;
b) measuring a release EMB motor speed, a release EMB voltage, and a release EMB actuator temperature during an open-loop release of the EMB pad;
c) determining that the apply and release EMB voltage magnitudes are within a predetermined voltage difference and that the apply and release EMB actuator temperatures are within a predetermined temperature difference;
d) determining that the apply and release EMB motor speed magnitudes are not within a predetermined motor speed difference; and
e) determining that the apply EMB motor speed magnitude is less than the release EMB motor speed magnitude which indicates drag of the EMB pad.

7. The method of claim 6, also including the step of initiating an open-loop apply of the EMB pad, and the step of initiating an open-loop release of the EMB pad.

8. The method of claim 7, wherein the open-loop apply of the EMB pad is initiated by an EMB electronic control unit and applies the EMB pad against a brake rotor, and wherein the open-loop release of the EMB pad is initiated by the EMB electronic control unit.

9. The method of claim 8, wherein the apply and release EMB actuator temperatures are the apply and release temperatures of an EMB actuator which includes an EMB motor having a shaft, which includes a ballscrew subassembly, and which includes gearing.

10. The method of claim 9, wherein EMB actuator temperature is EMB motor temperature, wherein EMB motor speed is derived from rotational position measurements of the shaft of the EMB motor, and wherein EMB voltage is bus voltage of the vehicle battery or voltage input to the EMB electronic control unit.

11. A method for calculating a no-load electric-mechanical-brake (EMB) actuator efficiency comprising:
a) measuring an apply EMB current, an apply EMB voltage, and an apply EMB actuator temperature during an open-loop apply of the EMB pad;
b) measuring a release EMB current, a release EMB voltage, and a release EMB actuator temperature during an open-loop release of the EMB pad;
c) determining that the apply and release EMB voltage magnitudes are within a predetermined voltage difference and that the apply and release EMB actuator temperatures are within a predetermined temperature difference;
d) determining that the apply and release EMB current magnitudes are within a predetermined current difference; and
e) calculating the no-load EMB actuator efficiency using at least the apply or release EMB current and a corresponding apply or release preselected EMB current.

12. The method of claim 11, wherein the no-load EMB actuator efficiency is equal to one minus a function of the difference between the apply or release EMB current and the preselected EMB current.

13. The method of claim 12, wherein the function equals the apply or release EMB current minus the preselected EMB current.

14. The method of claim 11, also including the step of initiating an open-loop apply of the EMB pad, and the step of initiating an open-loop release of the EMB pad.

15. The method of claim 14, wherein the open-loop apply of the EMB pad is initiated by an EMB electronic control unit and applies the EMB pad against a brake rotor, and wherein the open-loop release of the EMB pad is initiated by the EMB electronic control unit.

16. The method of claim 15, wherein the apply and release EMB actuator temperatures are the apply and release temperatures of an EMB actuator which includes an EMB motor, which includes a ballscrew subassembly, and which includes gearing.

17. The method of claim 16, wherein EMB actuator temperature is EMB motor temperature, wherein EMB current is current in the EMB motor, and wherein EMB voltage is voltage input to the EMB electronic control unit.

18. A method for calculating a no-load electric-mechanical-brake (EMB) actuator efficiency comprising:
a) measuring an apply EMB motor speed, an apply EMB voltage, and an apply EMB actuator temperature during an open-loop apply of the EMB pad;
b) measuring a release EMB motor speed, a release EMB voltage, and a release EMB actuator temperature during an open-loop release of the EMB pad;
c) determining that the apply and release EMB voltage magnitudes are within a predetermined voltage difference and that the apply and release EMB actuator temperatures are within a predetermined temperature difference;
d) determining that the apply and release EMB motor speed magnitudes are within a predetermined motor speed difference; and
e) calculating the no-load EMB actuator efficiency using at least the apply or release EMB motor speed and a corresponding apply or release preselected EMB motor speed.

19. The method of claim 18, wherein the no-load EMB actuator efficiency is equal to one minus a function of the difference between the preselected EMB motor speed and the apply or release EMB motor speed.

20. The method of claim 19, wherein the function equals the preselected EMB motor speed minus the apply or release EMB motor speed.

21. The method of claim 18, also including the step of initiating an open-loop apply of the EMB pad, and the step of initiating an open-loop release of the EMB pad.

22. The method of claim 21, wherein the open-loop apply of the EMB pad is initiated by an EMB electronic control unit and applies the EMB pad against a brake rotor, and wherein the open-loop release of the EMB pad is initiated by the EMB electronic control unit.

23. The method of claim 22, wherein the apply and release EMB actuator temperatures are the apply and release temperatures of an EMB actuator which includes an EMB motor having a shaft, a ballscrew subassembly, and gearing.

24. The method of claim 23, wherein EMB actuator temperature is EMB motor temperature, wherein EMB motor speed is derived from rotational position measurements of the shaft of the EMB motor, and wherein EMB voltage is voltage input to the EMB electronic control unit.
